(19) United States
(12) Patent Application Publication
(10) Pub. No.: US 2026/0061601 A1
(43) Pub. Date: Mar. 5, 2026

(54) GRIPPING DEVICE

(71) Applicants: Hyundai Motor Company, Seoul (KR); Kia Corporation, Seoul (KR)

(72) Inventors: Seung Hoon HAN, Singapore (SG); Wen Rong Vernon CHOW, Singapore (SG); Wai Yang CHAN, Singapore (SG); Wee Ching PANG, Singapore (SG); Wei Png CHUA, Singapore (SG)

(21) Appl. No.: 18/971,675

(22) Filed: Dec. 6, 2024

(30) Foreign Application Priority Data
Aug. 28, 2024 (KR) 10-2024-0116145

(51) Int. Cl. B25J 9/16; B25J 13/08; B25J 15/06

(52) U.S. Cl. CPC B25J 9/1612; B25J 13/087; B25J 15/0683

(57) ABSTRACT

A gripping device includes a plurality of grip modules configured to grip an object via suction applied to the surface of the object, a base part on which the plurality of grip modules is provided to be movable in an upward/downward direction or a leftward/rightward direction, and a controller configured to adjust movements of the grip modules or a movement of the base part based on property information including a material of the object, a degree of smoothness of a surface, or a weight or shape of the object.

### CROSS REFERENCE TO RELATED APPLICATIONS

The present application claims priority to Korean Patent Application No. 10-2024-0116145, filed on Aug. 28, 2024, the entire contents of which are incorporated herein for all purposes by this reference.

### TECHNICAL FIELD

The present disclosure relates to a gripping device capable of transferring components and the like, which are required to manufacture a product, to an assembling location.

### BACKGROUND

A single product is manufactured by combining different components. In a smart factory, these components may be transferred to an assembling location in various ways. For example, a robot can be used to pick and transfer a component from one location to another.

Robust picking and fast transferring of components would reduce the time required to manufacture products, thereby optimizing manufacturing efficiency. As a result, studies have been actively conducted to enhance component picking and transferring methods.

### SUMMARY

The present disclosure describes a gripping device that can quickly and accurately grip a variety of components and transfer them to an assembling location.

For example, a gripping device includes: a plurality of configurable grip modules to grip an object by using suction to adhere to its surface; a base part that allows the grip modules to move along all three axes-vertically (up/down), horizontally (left/right), and depth-wise (in/out); and a controller that adjusts the movements of the grip modules or the base part based on property information, such as material of the object, smoothness of its surface, or its weight and shape.

In some implementations, the base part may comprise three mechanisms to enable an adjustable matrix configuration. In some implementations, the base part may include three mechanisms to enable an adjustable matrix configuration.

For example, the first mechanism allows a plurality of grip modules to move in the depth-wise (in/out) direction along the Y axis. The second mechanism allows at least a pair of first mechanisms, which include a group of grip modules, to move in the horizontal (left/right) direction along the X axis. The third mechanism facilitates vertical (up/down) movements, allowing the grip modules to conform to various height contours and grip objects using suction, especially when the object lacks a sufficiently large flat surface.

The first mechanism may have one or more movable grip modules attached to it. The second mechanism may be provided two or more first mechanisms spaced apart from each other, positioned based on the center of the second mechanism, and configurable to move in leftward or rightward direction.

The controller may derive a specific suction point on the object based on the information about its properties.

The controller may calculate a required suction force based on the property information of the object, determine the configuration of the grip module required for suction based on the required suction force, and derive the target suction point based on the shape, curvature, or surface area of the object.

The controller may compute a single, continuous surface area or multiple parallel (or nearly parallel) surfaces in the XY-direction for suction grasping.

A three-dimensional representation of the object can be input into the controller, enabling detection and identification of all suction-grasping surfaces.

The controller can calculate the curvature and normal directions to identify surfaces and subsequently, identify the largest continuous flat graspable surface area.

When a single continuous flat graspable surface area is identified, the controller calculates the differences along both the X and Y axes to determine the spacing for the multiple grip modules in the determined configuration for suction.

In the absence of any grip module configuration capable of picking the calculated single continuous surface area, the controller can proceed to calculate the multiple parallel surfaces.

The controller can examine each identified surface and determine whether there are multiple surfaces that are parallel or nearly parallel to each other. When parallel surfaces are identified, it computes the vertical height variances along the Z-axis and calculates the differences along the X and Y axes to determine the spacing for multiple grip modules on these parallel surfaces for suction, factoring the height differences.

The grip module may include: a suction part, which consists of one suction cup (or multiple suction cups) to create suction and hold on to the object; and a rotational mechanism, especially when multiple suction cups are used, to switch between the cups. This rotation may be performed because different materials may require different types of suction cups for optimal grip and functionality.

The suction part may include a suction cup configured to adhere to the object, with the cup directly facing the object and making contact with its surface to create a vacuum effect.

The suction cups included in the plurality of grip modules may have the same suction area or different suction areas.

The rotational mechanism is a hinge bracket rotatably coupled to the lifting part and having a plurality of spaced ends; and a plurality of suction cups respectively provided at the spaced ends of the hinge bracket.

The plurality of suction cups may vary in their suction areas and are suitable for suctioning a variety of materials.

Taking into account the property information of the object, the controller can ascertain the appropriate suction cup needed for suctioning the object.

The controller may rotate the hinge bracket so that the appropriate suction cup is faced directly above the object for suction.

According to the present disclosure, it is possible to have a suction gripper apparatus that can quickly and accurately grasp components of various sizes, shapes, and weights for transfer to the assembling location. In particular, it is possible to derive the target suction point on the component by considering the material, weight, size, shape, and related characteristics, ensuring a secure grip during suction.

### BRIEF DESCRIPTION OF THE DRAWINGS

FIGS. 1 to 4 are views illustrating an example of a gripping device.

FIG. 5 is a view illustrating an example of a gripping device.

FIG. 6 is a view illustrating a suction part in FIG. 5.

FIG. 7 is a view for assisting in understanding the calculation of a required suction force.

FIGS. 8 and 9 are views for assisting in understanding the derivation of a required suction point on an object.

### DETAILED DESCRIPTION

Hereinafter, implementations disclosed in the present specification will be described in detail with reference to the accompanying drawings. Identical or similar constituent elements are denoted by the same reference numerals throughout, and redundant and repetitive descriptions thereof will be omitted.

In the description of the implementations disclosed in the present specification, the specific descriptions of publicly known related technologies will be omitted when it is determined that the specific descriptions may obscure the subject matter of the implementations disclosed in the present specification. In addition, the accompanying drawings are provided to allow those skilled in the art to easily understand the implementations disclosed in the present specification, and the technical essence disclosed in the present specification is not limited by the accompanying drawings, and includes all alterations, equivalents, and alternatives that fall within the essence and technical scope of the present disclosure.

The terms including ordinal numbers such as “first,” “second,” and the like may be used to describe various constituent elements, but the constituent elements are not limited by the terms. These terms are used to distinguish one constituent element from another constituent element.

Singular expressions include plural expressions unless clearly described as different meanings within the context.

In the present specification, it should be understood the terms “comprises,” “comprising,” “includes,” “including,” “containing,” “has,” “having” or other variations thereof are inclusive and therefore specify the presence of stated features, integers, steps, operations, elements, components, or combinations thereof, but do not preclude the presence or addition of one or more other features, integers, steps, operations, elements, components, or combinations thereof.

The suffixes “module”, “unit”, “part”, and “portion” used to describe constituent elements in the following description are used together or interchangeably in order to facilitate the description, but the suffixes themselves do not have distinguishable meanings or functions.

When one constituent element is described as being “coupled” or “connected” to another constituent element, it should be understood that one constituent element can be coupled or connected directly to another constituent element, and a intervening constituent element can also be present between the constituent elements. When one constituent element is described as being “coupled directly to” or “connected directly to” another constituent element, it should be understood that no intervening constituent element is present between the constituent elements.

A controller may include a communication device configured to communicate with another control unit or a sensor to control a corresponding function, a memory configured to store an operating system, logic instructions as well as input/output information, and one or more processors configured to perform determination, computation, decision, or the like required to control the corresponding function. In some examples, the controller may include an electric circuit or chip.

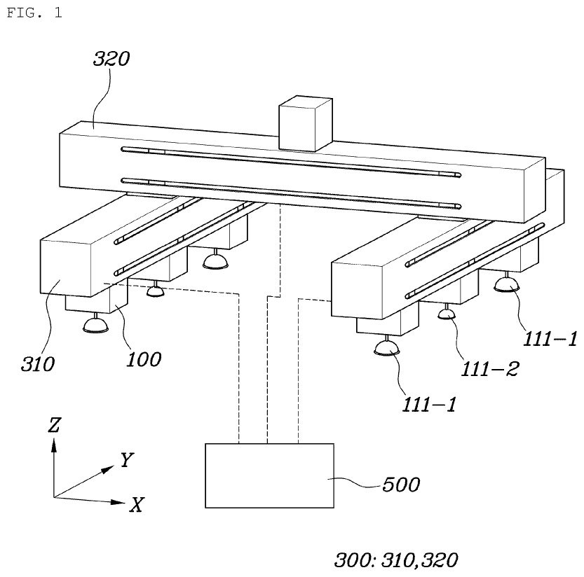

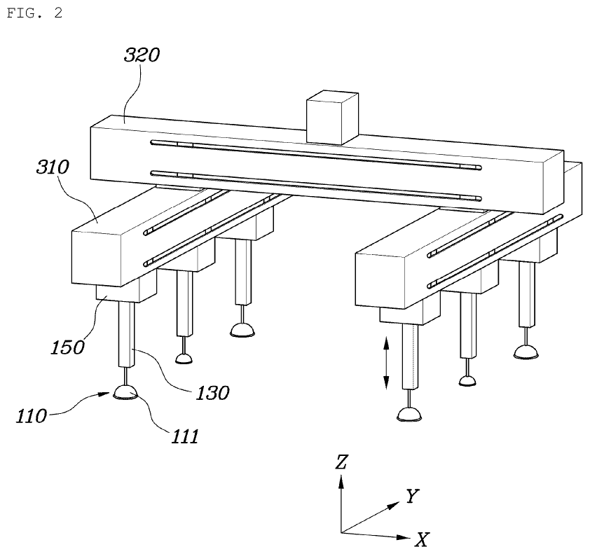

FIGS. 1 and 2 are views illustrating a gripping device according to an implementation of the present disclosure. With reference to FIGS. 1 and 2, the gripping device according to the present disclosure includes a plurality of grip modules 100 designed to grasp an object by creating suction on the surface of the object (component); a base part 300 allowing the array of grip modules to move along all three axes-vertically (up/down) along the Z axis, horizontally (left/right) along the X axis, and depth-wise (in/out) along the Y axis; and a controller 500 configured to adjust the movements of the grip modules 100 or the base part 300 based on property information including a material of the object, a degree of smoothness of a surface of the object, and a weight or shape of the object.

FIG. 1 illustrates an example of the gripping device. Multiple gripper devices may be provided. Although one gripper device is capable of picking and transferring a variety of components, one object may correspond to one gripping device, and one gripping device may transfer one object to an assembling location.

Transportation mechanisms (such as rails, robots or alternative methods) for moving the gripping devices may be provided at a designated location (e.g., smart factory), where objects are loaded. The gripping device can be moved to the loading area using these transportation mechanisms, grasp the object, and then transfer the object to the assembling area.

The transportation mechanisms may receive an object transfer signal from an object transfer system and move the gripping device to the location where the objects are loaded. The object to be transferred may be present below the gripping device, and the grip modules may grip the object by using suction to adhere to the surface of the object and then transfer the object to the assembling location.

In this case, various objects may be applied, and the objects may have various weights, shapes, and surface areas. Therefore, in order to optimally grip the object, the suction points of the grip module 100 may vary depending on factors such as the weight, shape, surface area, and other characteristics of the object being transferred.

In order to optimally grip the object, the suction points of the grip module 100 may also vary depending on the material of the object, the degree of smoothness of the surface of the object, and the weight or shape of the object.

In some implementations, the controller 500 can be configured to adjust the movements of the grip modules 100 or the movement of the base part 300 based on property information including the material of the object, the degree of smoothness of the surface of the object, and the weight or shape of the object.

The gripping device according to the present disclosure may assign unique identification codes to various objects, giving identical codes to identical objects, such that the gripping device may input the property information of the objects, which are measured in advance, to the controller 500 together with the identification codes.

In some implementations, the gripping device may be equipped with an image sensor such as a camera to acquire information on the material of the object, the degree of smoothness of the surface, or the shape in real time. The information acquired by the camera may be transferred to the controller 500 to acquire the property information.

In some examples, the controller 500 may derive an optimal point for gripping the object based on the property information of the object and adjust the movement of the grip module 100 or the movement of the base part 300 in order to ensure the grip module 100 securely holds the object via suction at the corresponding point.

The configuration in which the controller 500 derives the optimal point for gripping the object based on the property information of the object will be described below, and a configuration of the gripping device will be described in detail.

The gripping device may include, in broad terms, the grip module 100 and the base part 300. The base part 300 will be described. For example, the base part 300 may include one or more bases that each have a bar or beam shape extending in a longitudinal direction thereof. In some examples, the base part 300 may include first bases 310 on which the grip modules 100 are provided to be movable in the upward/downward direction y, and a second base 320 on which the first bases 310 having the grip modules 100 are provided to be movable in the leftward/rightward direction x. The first bases 310 and the second base 320 may be bars or beams that linearly extend.

The first base 310 may be coupled to the second base 320 and move in the leftward/rightward direction x relative to the second base 320. The second base 320 and the first base 310 may be coupled to each other by a ball-screw type or a rack-pinion type so that the first base 310 may linearly move on the second base 320.

In some examples, the first bases 310 may be provided as a pair of first bases 310 spaced apart from each other based on a center of the second base 320 and configured to be movable in the leftward/rightward direction x.

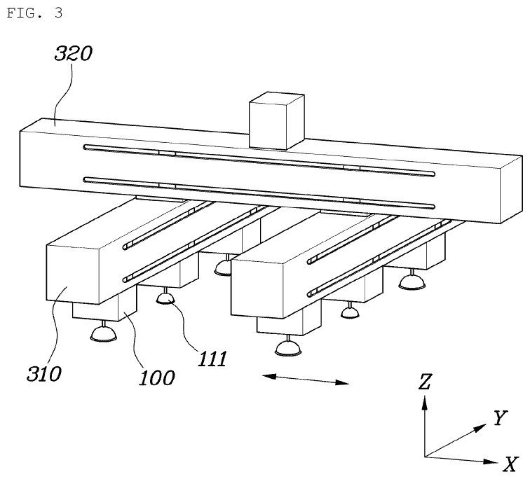

The first base 310 may move the grip module 100 leftward or rightward along the x direction, allowing the grip module 100 to suction objects at optimal points corresponding to the various object widths in x direction. (see FIG. 3).

The pair of first bases 310 may move independently of each other and move the grip modules 100 to the optimal points.

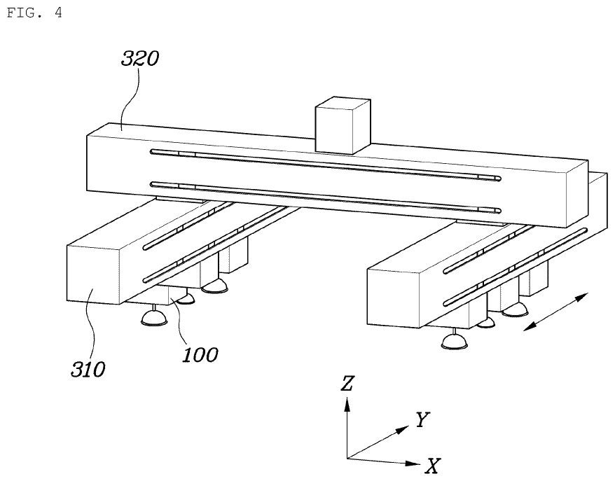

Furthermore, one or more grip modules 100 may be provided on the first base 310, and the grip module 100 may move in the upward/downward direction y on the first base 310 (see FIG. 4). The first base 310 may be provided to be fixed to the second base 320, but the present disclosure is not limited thereto. The first base 310 may move in the upward/downward direction y on the second base 320, and at the same time, the grip module 100 may also move in the upward/downward direction y.

The grip module 100, which is provided on the first base 310 so as to be movable in the upward/downward direction y, may move in the upward/downward direction y so that the grip module 100 may suction the object at the optimal point while corresponding to lengths of various objects in the longitudinal direction y.

The plurality of grip modules 100 provided on the first base 310 may move independently of one another, and some of the grip modules 100 may be fixedly installed on the first base 310. For example, in case that three grip modules 100 are provided on one first base 310 as illustrated in FIG. 1, the grip module 100 positioned at a middle position may be fixedly installed on the first base 310, and the remaining grip modules 100 may be installed to be movable in the upward/downward direction with the grip module 100 positioned at the middle position interposed therebetween.

Hereinafter, the grip module 100 will be described. The grip module 100 may include a suction part 110 configured to suction the object, a lifting part 130 equipped with the suction part 110 and configured to move the suction part 110 in a height direction z while being retracted or extended in the height direction, and a movement part 150 equipped with the lifting part 130 and configured to move the suction part 110 in the upward/downward direction.

With reference to FIG. 2, the suction part 110 may have a shape opened toward the object and include a suction cup 111 configured to come into contact with the surface of the object and perform vacuum suction. The suction part 110 may grip the object by using the suction cup 111.

The lifting part 130 may be provided to bring the suction cup 111 into contact with the surface of the object, and the suction cup 111 may be moved in the height direction by an operation of the lifting part 130 (see FIG. 2).

The lifting part 130 may have a rectangular shape or a pipe shape and move the suction cup 111 in the Z-axis direction while being retracted and extended. The lifting part 130 may be provided on the movement part 150 and configured to be retracted and extended in a telescopic manner. When the lifting part 130 is completely retracted, the lifting part 130 may be accommodated inside the movement part 150.

The lifting part 130 may be coupled to the movement part 150, and the movement part 150 may be coupled to the first base 310 so that the movement part 150 may move in the Y-axis direction on the first base 310, such that the suction cup 111 may be moved in the Y-axis direction by the motion of the movement part 150.

In some examples, the suction cups 111 included in the plurality of grip modules 100 may have the same suction area or different suction areas. For example, as illustrated in FIG. 1, in case that three suction cups 111 are provided on one first base 310, a suction area of a suction cup 111-2 provided at a center may be different from a suction area of each of the remaining suction cups 111-1.

The reason why the suction areas are different is to use the suction cup 111 suitable for the properties of the objects having various materials, weights, shapes, and the like. For example, in the case of flexible objects, the suction area may be increased so that the suction force is not concentrated in a small part of the object to prevent damage during the process of transferring the object. Alternatively, in case that the surface of the object is uneven, the suction area may be increased to prevent the object from being separated from the gripping device by gravity during the process of transferring the object.

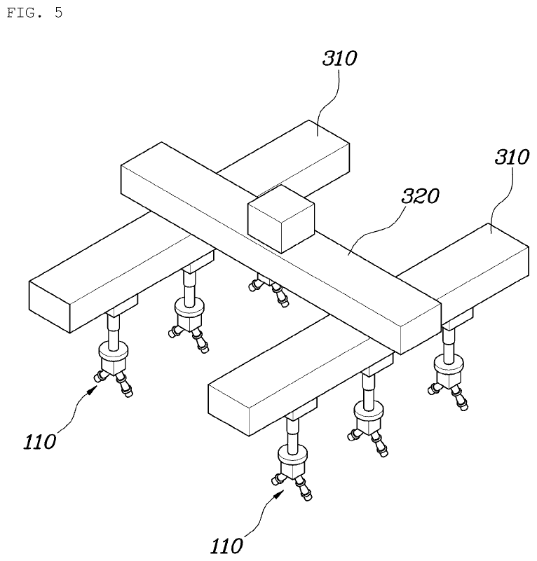

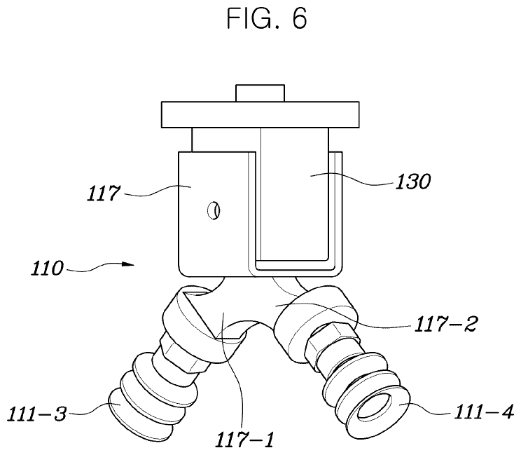

In some examples, FIG. 5 is a view illustrating a gripping device according to another implementation of the present disclosure, and FIG. 6 is a view illustrating a suction part according to another implementation. With reference to FIGS. 5 and 6, in another implementation, it can be seen that the suction part is modified.

Specifically, the suction part may include a hinge bracket 117 that is rotatably coupled to the lifting part 130 and has a plurality of spaced ends, and a plurality of suction cups 111-3 and 111-4 respectively provided at the spaced ends of the hinge bracket 117. In some examples, the plurality of suction cups 111-3 and 111-4 may be disposed at one end of the hinge bracket 117.

The plurality of suction cups 111-3 and 111-4 may have varying suction areas. The controller 500 can select the appropriate suction cups for object grasping based on the property information of the objects. Additionally, upon selecting a specific suction cup based on the property information, the controller 500 can rotate the hinge bracket 117 to position the chosen suction cup directly above the object.

As described above, various suction cups 111-3 and 111-4, which may correspond to the properties of various objects, may be provided on the hinge bracket 117 and used to grip the objects. In some implementations, at least two or more suction cups may be provided on the hinge bracket 117.

The lifting part 130 may include a motor configured to rotate the hinge bracket 117. The controller 500 may control the motor and rotate the hinge bracket 117 so that the required suction cup 111 is disposed above the object.

Hereinafter, a process of deriving, by the controller 500, the optimal point for gripping the object based on the property information of the object will be described. A 3D file related to the object may be inputted to the controller 500. In particular, a three-dimensional (3D) computer-aided design (CAD) file may be inputted to the controller 500. The controller 500 may analyze all cross-sections of the object. The above-mentioned process may be performed before the object is transferred. When the result is derived by the controller 500, a manager adjusts a direction in which the objects are loaded based on the result values derived by the controller 500, such that an optimal cross-section may face the gripping device.

Specifically, the controller 500 may identify surfaces through curvatures of the surfaces of the object and normal directions of the surfaces of the object and derive a suction target point on the surface that has the largest surface area among the identified surfaces. The controller 500 may derive a target suction point, which corresponds to an optimal gripping point on the object, based on the property information including the material of the object, the degree of smoothness of the surface, the weight, or the shape.

First, the controller 500 may calculate the required suction force based on the property information of the object. The required suction force is a minimum suction force required to grip the object. The required suction force may be calculated based on Equation 1 below.

$$F = m \times ( g + \frac{a}{μ} ) \times S \qquad [ Equation 1 ]$$

The factors are as follows.
F: Required suction force
m: Mass of object
g: Gravitational acceleration
a: Acceleration in transfer direction of object
μ: Frictional coefficient between object and suction cup (0<μ≤1)
S: Safety factor

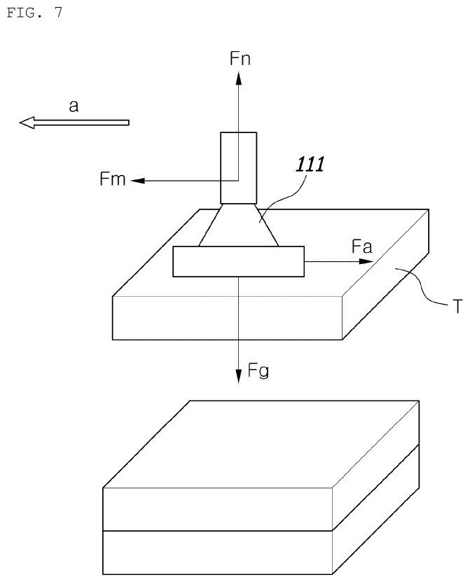

With reference to FIG. 7, the required suction force [F] may be calculated based on [Fn+Fm]. [En] is equal to a force applied by gravity applied to an object T, and [Fm] is a force applied opposite to [Fa] that is a force applied in the transfer direction of the object T.

In some examples, because a relationship of [Fm]> [Fa] needs to be implemented to move the object T in the transfer direction, [Fa=−ma/μ] may be defined. Therefore, the required suction force may be calculated based on the above-mentioned equation.

In some examples, the acceleration a in the transfer direction of the object is a value to be inputted to the object transfer system that controls the rail configured to transfer the gripping device, and the acceleration a may be determined as a constant. The frictional coefficient μ between the object T and the suction cup 111 may also be determined as a value derived from experiments.

The safety factor S may be arbitrarily set by the manager. Particularly, the safety factors may be set differently depending on the types of objects. For example, the safety factor may have a value of 1.2 to 1.5 when the surface of the object is smooth. In case that the surface of the object is porous or the surface is coated with a slippery material or rough, the safety factor may have a value of 1.5 to 2.

The equation for calculating the required suction force is provided to assist in understanding the present disclosure. The equation for calculating the required suction force may vary depending on the motion of the gripping device. The required suction force may be calculated based on a surface area or volume of the object.

In some examples, when the required suction force is calculated, the appropriate number of grip modules 100 required to securely grip the object may be determined. That is, the number of required grip modules 100 may be determined based on the required suction force.

A level according to a range of the required suction force is inputted to the controller 500, and the number of grip modules 100 required to securely grip the object according to the level corresponding to the calculated required suction force.

For example, when the required suction force (units omitted) is d or higher and lower than e, level 1 may be inputted to the controller 500. In addition, level 2 may be inputted to the controller 500 when the required suction force is f or higher and lower than g, level 3 may be inputted to the controller 500 when the required suction force is h or higher and lower than i, level 4 may be inputted to the controller 500 when the required suction force is j or higher and lower than k, and level 5 may be inputted to the controller 500 when the required suction force is 1 or higher.

The use of one grip module 100 may be determined at level 1, the use of two grip modules 100 may be determined at levels 2 and 3, the use of four grip modules 100 may be determined at level 4, and the use of six or more grip modules 100 may be determined at level 5.

Therefore, when the level is determined based on the calculated required suction force, the number of required grip modules 100 is determined. When the required grip module 100 is determined, the controller 500 may derive the target suction point based on a cross-sectional shape, curvature, or surface area of the object.

Specifically, in order to perform the vacuum suction of the suction cup 111, a search for a flat surface is required, and the controller 500 searches for a cross-section of the object that has a cross-sectional curvature smaller than a reference curvature. When the cross-sectional curvature of the object is smaller than the reference curvature, the surface of the object may be considered as a flat surface.

Thereafter, when there is a cross-section having a curvature smaller than the reference curvature, the controller determines whether a surface area of the cross-section is larger than a reference surface area. In case that there is a cross-section having a surface area larger than the reference surface area, the controller 500 may set the target suction point on the cross-section. That is, the target suction point may be set in case that the surface area of the cross-section is sufficient to be set as the target suction point in consideration of the suction area or the like of the suction cup 111 even though there is a flat surface.

In this case, the reference surface area may be set to vary depending on the levels of the required suction force. The suction area may vary depending on the type of suction cup 111. This is because the effective suction area increases proportionally with the number of deployed grip modules 100. For example, in the case of level 1 at which one grip module 100 is used and level 4 at which four grip modules 100 are used, minimum surface areas required to set the target suction point are different. Therefore, the reference surface area may be set to vary depending on the level of the required suction force.

In addition, in case that there is a plurality of cross-sections having surface areas larger than the reference surface area, the controller 500 may set the target suction point on the largest cross-section to the secure gripping may be performed. The controller 500 may set the target suction point on at least one edge of the cross-section so that the secure gripping may be performed.

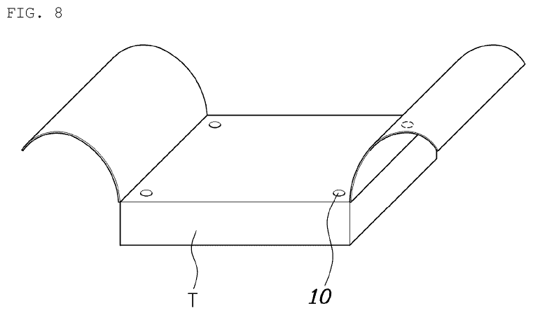

For example, the level of the required suction force required to grip the object T is level 4. In case that the surface area of the cross-section having a curvature smaller than the reference curvature exceeds the reference surface area, a target suction point 10 may be set, as illustrated in FIG. 8.

In some examples, there may be a case in which the controller 500 cannot detect a flat, single continuous surface. In this case, the controller 500 may search for a plurality of discontinuous flat surfaces that has cross-sections having curvatures smaller than the reference curvature and has surface areas smaller than the reference surface area. In addition, the controller 500 may derive target suction points on the discontinuous flat surfaces based on heights of the plurality of searched discontinuous flat surfaces and X-axis and Y-axis lengths of the plurality of searched discontinuous flat surfaces.

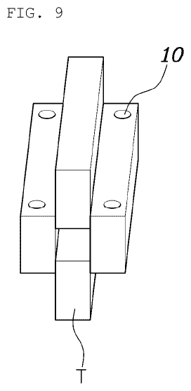

For example, with reference to FIG. 9, the controller 500 may define groups of adjacent cross-sections, select a group of cross-sections having the smallest height difference from the defined group or select a group of cross-sections, a sum of surface areas of which is largest, from the defined group. Further, the controller 500 may select the cross-sections included in the group and set the target suction points 10 on the cross-sections. In this case, the controller 500 may set the target suction point on at least one edge of the cross-section.

According to the above-mentioned description, the target suction point is set before the object is transferred. In some implementations, the controller may search for a cross-section, which is observed in a state in which the object is placed, in real time by using an image sensor such as a camera included in the gripping device. The controller may divide the object into the plurality of cross-sections based on the shape of the object (a partition wall, whether portions having a height difference are present, or the like) in the state in which the object is placed, and then the controller may search for the respective cross-sections. Thereafter, when there is a cross-section having a curvature smaller than the reference curvature, the controller may determine whether a surface area of the cross-section exceeds the reference surface area, and the controller may set the target suction point in the same way as the above-mentioned description.

While the specific implementations of the present disclosure have been illustrated and described, it will be obvious to those skilled in the art that the present disclosure may be variously modified and changed without departing from the technical spirit of the present disclosure defined in the appended claims.

What is claimed is:

1. A gripping device comprising:
a base part;
a plurality of grip modules disposed at the base part and configured to grip an object by applying suction to a surface of the object, the plurality of grip modules being configured to move relative to the base part in an X-axis direction, a Y-axis direction orthogonal to the X-axis direction, or a Z-axis direction orthogonal to the X-axis direction and the Y-axis direction; and
a controller configured to adjust movements of the plurality of grip modules or a movement of the base part based on property information including a material of the object, a degree of smoothness of the surface of the object, a weight of the object, or a shape of the object.

2. The gripping device of claim 1, wherein the base part comprises a first base and a second base,
wherein the plurality of grip modules are movably coupled to the first base and configured to move relative to the first base in the Y-axis direction, and
wherein the first base is movably coupled to the second base and is configured to move relative to the second base in the X-axis direction.

3. The gripping device of claim 2, wherein the first base is one of a pair of first bases that are spaced apart from each other in the X-axis direction and that are configured to move relative to a center of the second base in the X-axis direction.

4. The gripping device of claim 3, wherein the plurality of grip modules comprise one or more grip modules disposed at one of the pair of the first bases.

5. The gripping device of claim 1, wherein the controller is configured to determine a target suction point at the object based on the property information.

6. The gripping device of claim 5, wherein the controller is configured to receive input of three-dimensional data of the object and to determine the target suction point at the surface of the object based on the three-dimensional data.

7. The gripping device of claim 6, wherein the controller is configured to:
identify a plurality of surfaces based on a curvature and a normal direction of the plurality of surfaces of the object; and
determine the target suction point at one of the plurality of surfaces that has the largest surface area among the plurality of surfaces.

8. The gripping device of claim 5, wherein the controller is configured to:
search for a single continuous surface of the object that has (i) a cross-sectional curvature less than a reference curvature and (ii) a cross-sectional area exceeding a reference surface area; or
search for a plurality of discontinuous surfaces that each have (i) a cross-sectional curvature less than the reference curvature and (ii) a cross-sectional area less than the reference surface area.

9. The gripping device of claim 8, wherein the controller is configured to, in response to the single continuous surface not being found from the object, search for the plurality of discontinuous surfaces.

10. The gripping device of claim 9, wherein the controller is configured to:
determine the target suction point at the plurality of discontinuous surfaces based on Z-axis lengths, X-axis lengths, and Y-axis lengths of the plurality of discontinuous surfaces.

11. The gripping device of claim 5, wherein the controller is configured to determine a spacing of the plurality of grip modules based on an X-axis length of the surface of the object and a Y-axis length of the surface of the object.

12. The gripping device of claim 1, wherein each of the plurality of grip modules comprises:
a suction part configured to suction the object;
a lifting part movably coupled to the suction part and configured to retract or extend in the Z-axis direction to thereby move the suction part in the Z-axis direction; and
a movement part movably coupled to the lifting part and configured to move the suction part in the Y-axis direction.

13. The gripping device of claim 12, wherein the suction part comprises a suction cup configured to couple to the object by suction, the suction cup having a shape opened toward the object and being configured to come into contact with the surface of the object and to perform vacuum suction.

14. The gripping device of claim 13, wherein the suction cup of each of the plurality of grip modules has a same suction area.

15. The gripping device of claim 13, wherein the suction cups of the plurality of grip modules have different suction areas from one another.

16. The gripping device of claim 12, wherein the suction part comprises:
a hinge bracket rotatably coupled to the lifting part; and
a plurality of suction cups disposed at an end of the hinge bracket.

17. The gripping device of claim 16, wherein the plurality of suction cups have different suction areas.

18. The gripping device of claim 16, wherein the controller is configured to determine one of the plurality of suction cups for gripping the object based on the property information.

19. The gripping device according to claim 16, wherein the controller is configured to maneuver the hinge bracket to position one of the plurality of suction cups directly above the object for suction engagement.

20. The gripping device according to claim 1, wherein the base part comprises one or more beams that linearly extend.
